(19) United States
(12) Patent Application Publication
(10) Pub. No.: US 2017/0116844 A1
(43) Pub. Date: Apr. 27, 2017

(54) ADAPTIVE ALERT DEVICE

(71) Applicant: Suzanne Brean, (US)

(72) Inventor: Suzanne Brean, Lebanon, OR (US)

(21) Appl. No.: 15/335,360

(22) Filed: Oct. 26, 2016

Related U.S. Application Data
(60) Provisional application No. 62/246,496, filed on Oct. 26, 2015.

(51) Int. Cl. G08B 25/01; G08B 25/12

(52) U.S. Cl. CPC G08B 25/016; G08B 25/12

(57) ABSTRACT

An adaptive alert device permits a service animal, e.g., a trained service dog, to activate a standard auto-dialer pendant in an emergency situation. The auto-dialer pendant may be part of a pendant system. The adaptive alert device includes a housing and platform in the form of an enlarged activation button. The housing is designed to secure the pendant in a fixed position. When the service animal depresses the activation button, the button exerts pressure on the pendant and so activates the pendant in place of a human being doing so. The adaptive alert device therefore extends the usefulness of the pendant system. The housing may be further equipped to provide different modes of activation, for example, sound or light instead of pressure. The adaptive alert device can be operated by small children, other service animals such as trained primates, or by machines.

### CROSS-REFERENCE TO RELATED APPLICATIONS

This patent application claims priority from U.S. Provisional Patent Application Ser. No. 62/246,496, entitled “ADAPTIVE ALERT DEVICE,” filed Oct. 26, 2015, which is hereby incorporated by reference in its entirety for all purposes.

### FIELD

The present disclosure relates generally to placing emergency calls and alerts, and more specifically to devices for use in summoning assistance in an emergency.

### BRIEF SUMMARY

Auto-dialers are devices that automatically dial a selected telephone number when activated. Typically, an auto-dialer for use in emergency situations is activated by an alert device in the form of a pendant that can be worn around a person's neck or wrist. The pendant may be suspended by a lanyard or a chain, for example. The pendant may be activated by pressing an external or internal button on the pendant, by activating a switch, or by otherwise engaging a sensor. In response, the pendant communicates wirelessly with a remote device, e.g., a remote telephonic base station, and causes the remote device to dial a pre-programmed number. The remote device can be, for example, a telephone, a mobile phone, a node on a 3G, 4G, or LTE wireless network, or a computing device equipped with Voice-Over-Internet Protocol (VOIP). Use of a dedicated auto-dialer facilitates contacting first responders such as police, fire, or medical personnel via 9-1-1. Alternatively, the auto-dialer can be pre-set to directly dial a hospital, a neighbor, a care-giver, a family member, or any other pre-selected entity. Multiple pendants may be provided as a pendant system for one individual or household, in which the pendants are connected to an auto-dialer that is programmed to call the same telephone number or different telephone numbers. For example, in addition to wearing a pendant on a lanyard, a person may also have a second pendant located in a bathroom in case they fall in the shower. Alternatively, a pendant system may be installed in a home for use as a home security system to alert police to the presence of an intruder. Many elderly and/or disabled people and their families derive peace of mind from a single auto-dialer pendant, or from a system of auto-dialer pendants.

An adaptive alert device is disclosed herein for use with an existing auto-dialer pendant. The auto-dialer pendant may be part of a pendant system. The adaptive alert device permits a non-human entity such as a service animal, e.g., a trained service dog, to activate a standard pendant in an emergency situation. The adaptive alert device includes a housing and an enlarged activation button. The housing is designed to receive an auto-dialer pendant and hold the pendant in a fixed position. When the service animal depresses the activation button, the button exerts pressure on the pendant and so activates the pendant in place of a human being doing so. The pendant connects wirelessly with a remote auto-dialer that automatically dials one or more selected telephone numbers to obtain assistance. When a connection is made with a responder, the remote auto-dialer may deliver a pre-recorded message and a location of the alert device. The adaptive alert device therefore extends and enhances the usefulness of the pendant system. The housing may be further equipped to provide different modes of activation, for example, activation by sound or light instead of pressure. Furthermore, the adaptive alert device can be operated by small children, trained animals other than service dogs, or machines.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1 is a front plan view of an adaptive alert device, according to some embodiments of the present disclosure as described herein.

FIG. 2 is a perspective view of the adaptive alert device shown in FIG. 1.

FIG. 3 is a side elevation view of the adaptive alert device shown in FIG. 1.

FIG. 4 is a back plan view of the adaptive alert device shown in FIG. 1.

FIG. 5 is a cross-sectional view of the adaptive alert device as shown in FIG. 4.

FIG. 6 is a block diagram of a communication system that includes the adaptive alert device shown in FIGS. 1-5.

FIGS. 7-9 are plan views of a base of the adaptive alert device shown in FIGS. 1-5.

FIGS. 10-12 are plan views of a cover of the adaptive alert device shown in FIGS. 1-5.

FIG. 13 is a side elevation view of an actuator for use in an adaptive alert device, according to some embodiments of the present disclosure as described herein.

FIG. 14 is a top plan view of the actuator shown in FIG. 13.

FIG. 15 is a top plan view of the actuator shown in FIG. 13.

### DESCRIPTION OF EMBODIMENTS

The following description sets forth exemplary devices, methods, parameters, and the like. It should be recognized, however, that such description is not intended as a limitation on the scope of the present disclosure but is instead provided as a description of exemplary embodiments.

Terminology used in the description of the various described embodiments herein is for the purpose of describing particular embodiments only and is not intended to be limiting. As used in the description of the various described embodiments and the appended claims, the singular forms “a”, “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

In the following description, certain specific details are set forth in order to provide a thorough understanding of various aspects of the disclosed subject matter. However, the disclosed subject matter may be practiced without these specific details. In some instances, well-known structures and methods comprising embodiments of the subject matter disclosed herein have not been described in detail to avoid obscuring the descriptions of other aspects of the present disclosure.

Reference throughout the specification to “one embodiment,” “an embodiment,” or “some embodiments,” means that a particular feature, structure, or characteristic described in connection with the embodiment(s) is included in at least one embodiment. Thus, the appearance of the phrases “in one embodiment,” “in an embodiment,” or “in some embodiments,” in various places throughout the specification are not necessarily all referring to the same aspect. Furthermore, the particular features, structures, or characteristics may be combined in any suitable manner in one or more aspects of the present disclosure.

Specific embodiments are described herein with reference to adaptive alert devices that have been produced; however, the present disclosure and the reference to certain materials, dimensions, and the details and ordering of processing steps are exemplary and should not be limited to those shown.

The terms “pendant” and “auto-dialer pendant” as used herein, refer to any device or set of devices configured to activate an auto-dialer.

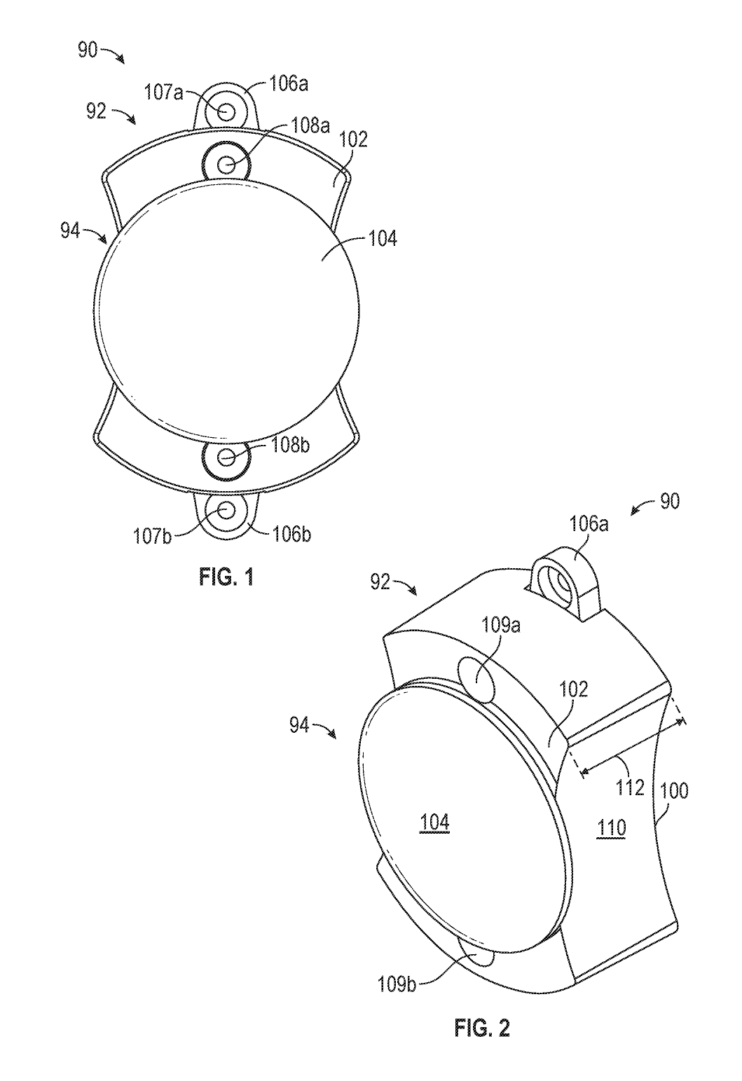

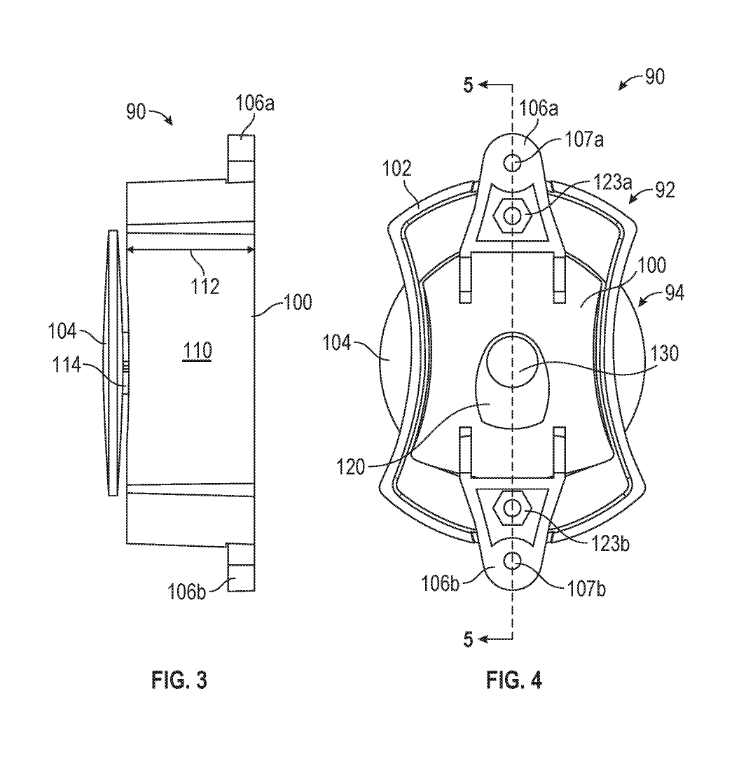

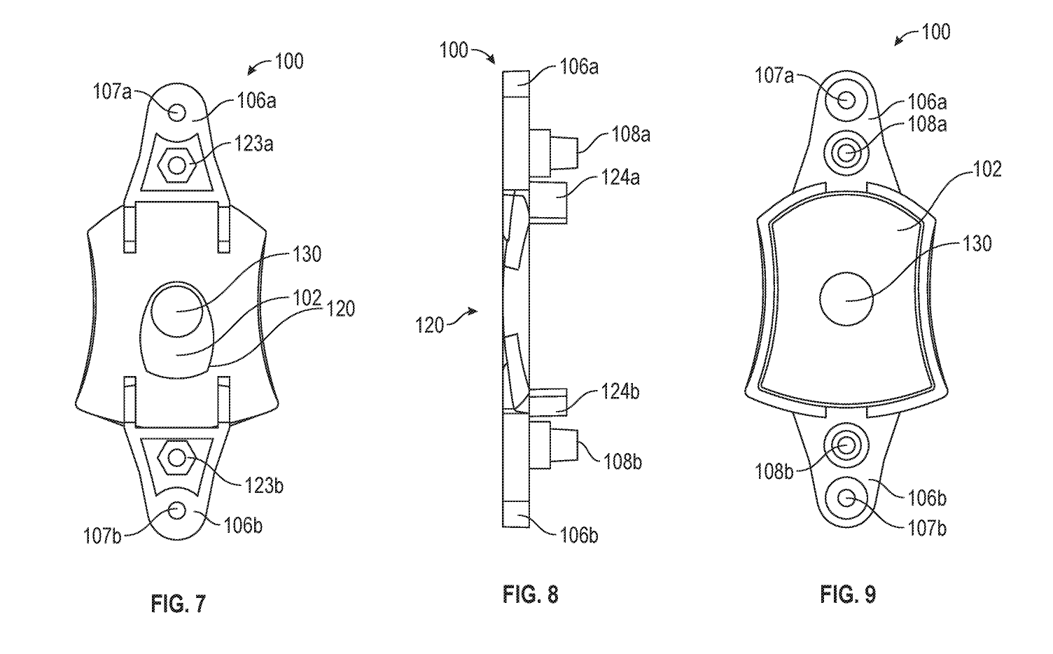

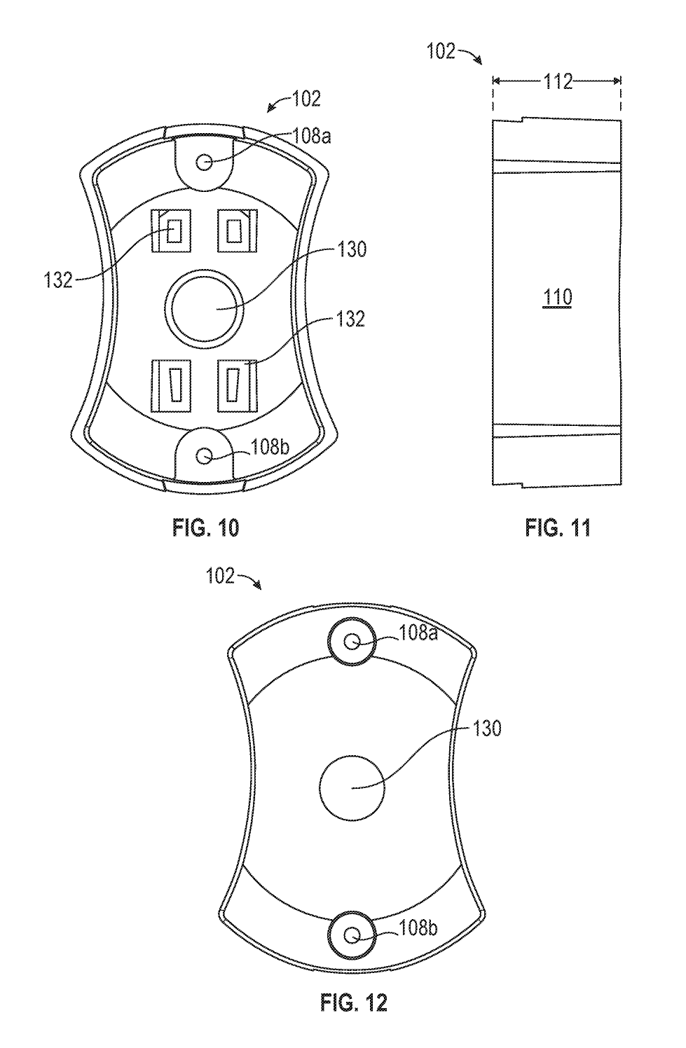

Turning now to the figures, FIGS. 1-3 show top plan, perspective, and side elevation views, respectively, of an adaptive alert device 90, according to some embodiments of the present disclosure. The adaptive alert device 90 includes a housing 92 and an actuator 94. The housing 92 forms an enclosure for containing and activating an existing alert device, for example, in the form of a conventional alert pendant. The housing 92 includes a base plate 100 (FIGS. 7-9) and a cover 102 (FIGS. 10-12). The cover 102 of the housing 92 may be made of a rigid material so as to protect components, e.g., electronic components, disposed within the housing 92. The base plate 100 includes mounting tabs 106a,b having screw holes 107a,b that permit securing the base plate 100 to a wall, a floor, or any supporting object, using mounting screws 105a,b. The cover 102 is secured to the base plate 100 by attachment bolts 109a,b that extend through bolt openings 108a,b. The cover 102 has sides 110 of a depth 112.

The actuator 94 includes a platform 104 and a shaft 114. In some embodiments, the platform 104 is in the form of a button designed so that a child, or a non-human entity, e.g., a trained animal, can depress the actuator 94 in an emergency. An upper surface of the platform 104 may be non-convex, e.g., a flat surface or a slightly concave surface, so that the animal can depress the platform 104 intentionally, but not accidentally. The platform 104 can be soft or rigid, and can be made from a variety of materials that can be painted or otherwise manufactured in various colors that service animals can see. For example, in some embodiments the platform 104 has a color that reflects light of a wavelength that is visible to dogs. Dogs are known to see violet, red, and grey, but not yellow. In some embodiments, an adaptive alert device 90 designed for a service dog may have an actuator 94 that is, for example, bright red or violet in color, while the housing 92 is white, to facilitate the service dog locating the alert device 90 easily and distinguishing the alert device 90 from its surroundings. The platform 104 may be 2-3 inches in diameter to provide a touch surface for dog paws of various sizes. The actuator 94 may come in different sizes and colors for use with different sizes or types of service animals.

FIG. 4 shows a back view of the adaptive alert device 90, from underneath the base plate 100, according to some embodiments of the present disclosure. The base plate 100 may include hex nuts 123a,b to secure the bolts 109a,b that attach the cover 102 to the base plate 100. The base plate 100 has an opening 120 that allows a user to view the pendant 122 without having to remove the cover 102. In some embodiments, the opening 120 has a regular shape, e.g., circular, while the pendant is elongated, e.g., oval-shaped.

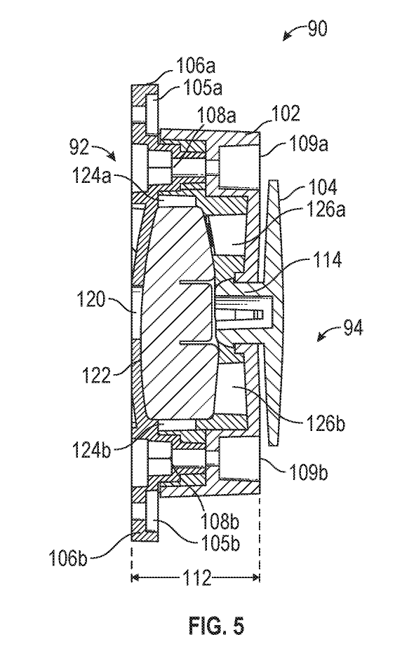

FIG. 5 shows a cross-sectional view of the adaptive alert device 90, according to some embodiments of the present disclosure. The cross-sectional view shown is along a vertical cut line through the center of the adaptive alert device 90. In FIG. 5, a pendant 122 is shown installed in the housing 92. The pendant 122 can be inserted into the housing 92 by removing the cover 102. The pendant 122 is secured in a fixed position within the housing 92 by brackets 124a,b that permit the pendant to snap into the housing 92. In some embodiments, the brackets 124a,b may be adjustable to facilitate use with a variety of pendant styles, of different dimensions. Motion of the pendant 122 is further constrained by stops 126a,b. A proximal end of the shaft 114 snaps into a position that holds the platform 104 spaced apart from the top surface of the cover 102, while a distal end of the shaft 114 is in contact with the pendant 122. The pendant 122 includes a sensor, typically a pressure sensor in the form of a spring or a component that exhibits spring tension. Alternatively, the pendant may include a light sensor or an audio sensor, or other types of sensors.

In some embodiments, relative dimensions of the various parts described above may be as follows: The distance between the upper and lower screw holes 107a,b is about 3.75 inches, while the platform 104 has a diameter of about 2.5 inches and the depth 112 of the cover 102 is about 1.2 inches. The opening 120 in the base plate 100 may be about 1 cm wide and 2 cm long.

In operation, pressure applied in a direction transverse to the platform 104, causes the distal end of the shaft 114 to contact the pendant 122. The platform 104 may be provided in many different shapes and sizes. The platform 104 desirably has a surface area that is substantially larger, e.g., at least about three times larger, than the portion of the surface area of the pendant 122 that is in contact with the shaft 114. Pressure applied to the platform 104 is thus efficiently transferred to the pendant 122.

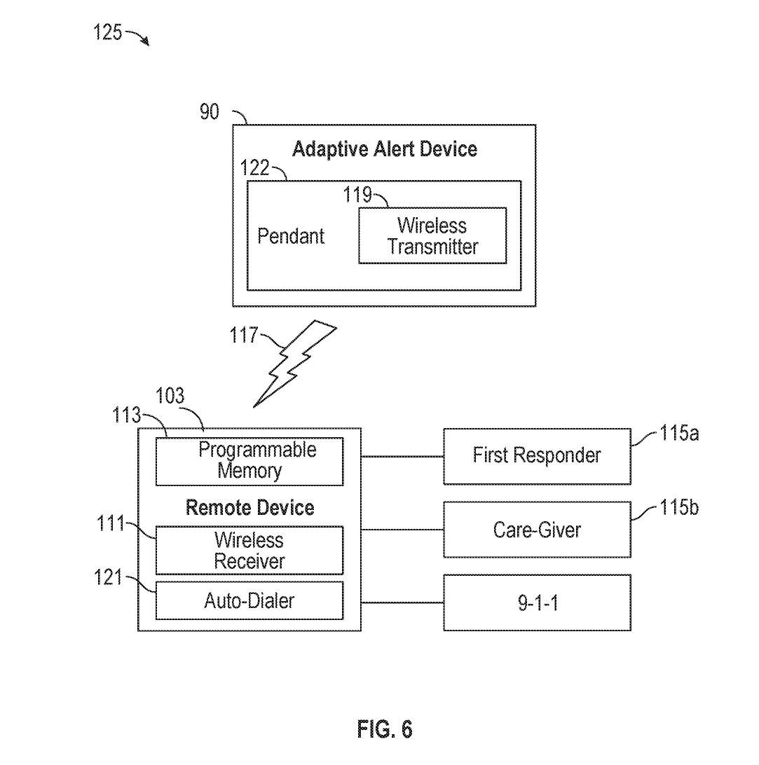

FIG. 6 shows a communication system 125 that connects the adaptive alert device 90, with a remote device 103 configured to contact responders 115, according to some embodiments of the present disclosure. The remote device 103 includes a wireless receiver 111, a programmable memory 113, and an auto-dialer 121. The wireless transmitter 119 in the alert device 90 communicates with the remote device 103 via a wireless signal 117. In response to engagement of the actuator 94, the wireless transmitter 119 inside the pendant 122 sends the wireless signal 117 to the remote auto-dialer 121 of the remote device 103, located at a remote destination. It is understood that the pendant 122 includes its own power supply and the radio frequency (RF) wireless transmitter 119 to support communication with the remote device 103, and that these items need not be supplied as part of the housing 92. However, some embodiments may provide power to the pendant 122, and the housing 92 may be modified to accommodate a power cord or a connection to a battery re-charging device. The housing 92 is made of a non-conductive material that permits wireless communication between the alert device and an auto-dialer located at a remote destination.

The remote device 103 is configured with the wireless receiver 111 that receives the wireless signal 117. Upon receipt of the wireless signal 117 from the pendant 122, the remote auto-dialer 121 identifies the pendant 122, and then dials a selected telephone number associated with the pendant 122. The selected telephone number may be stored in the programmable memory 113 e.g., a PROM or EPROM, of the remote auto-dialer 121. The remote auto-dialer 121 can be programmed, for example, to dial one or more pre-selected telephone numbers in succession. Such pre-selected telephone numbers may be associated with responders 115 such as a first responder 115a, e.g., an emergency crew or an ambulance service; a care-giver 115b; or a neighbor, or the like. When calls to the pre-selected telephone numbers are not answered, the remote auto-dialer 121 can be programmed to dial another telephone number, e.g., 9-1-1. When a call is answered, the remote auto-dialer 121 delivers a pre-recorded message, e.g., a digital recorded message, in order to direct assistance to the location of the pendant 122. The pre- recorded message may include, for example, the following: “An emergency situation has been detected at the home of <XYZ>, located at <ABC>. Please send assistance immediately!” The remote auto-dialer 121 may also be programmed to determine the location of the pendant 122 from the received wireless signal 117, and to relay the location of the pendant 122 in the recorded message. The location of the pendant 122, e.g., a person's home address, may be stored in the programmable memory 113.

The communication system 125 thus described automatically summons assistance when an individual cannot call for help on their own, for example, when the individual is unconscious. In such instances, service animals are trained to detect the individual's distress, and to engage the actuator 94. Similarly, a small child may asses the emergency situation and may be capable of engaging the actuator 94. Likewise, the present inventor envisions that service machines currently under development may be programmed to engage the actuator 94. The adaptive alert device and the communication system 125 described herein therefore extend the current capability of existing pendant systems that are not fully automatic and still rely on some level of input from the individual in distress.

FIGS. 7, 8, and 9 show back, side, and front views, respectively, of the housing 92 and, in particular, the base plate 100, according to some embodiments of the present disclosure. In the side view of FIG. 8, the base plate 100 is shown alone, with the cover 102 and the actuator 94 removed. In FIGS. 7 and 9, the base plate 100 and portions of the cover 102 are shown, with the actuator 94 having been removed. The top side of the cover 102 has an opening 130, into which the shaft 114 is inserted as described below in more detail.

FIGS. 10, 11, and 12 show underside, side, and top views, respectively, of the cover 102 according to some embodiments of the present disclosure. The underside of the cover 102 shown in FIG. 10 includes protrusions 132 that help to stabilize the pendant 122.

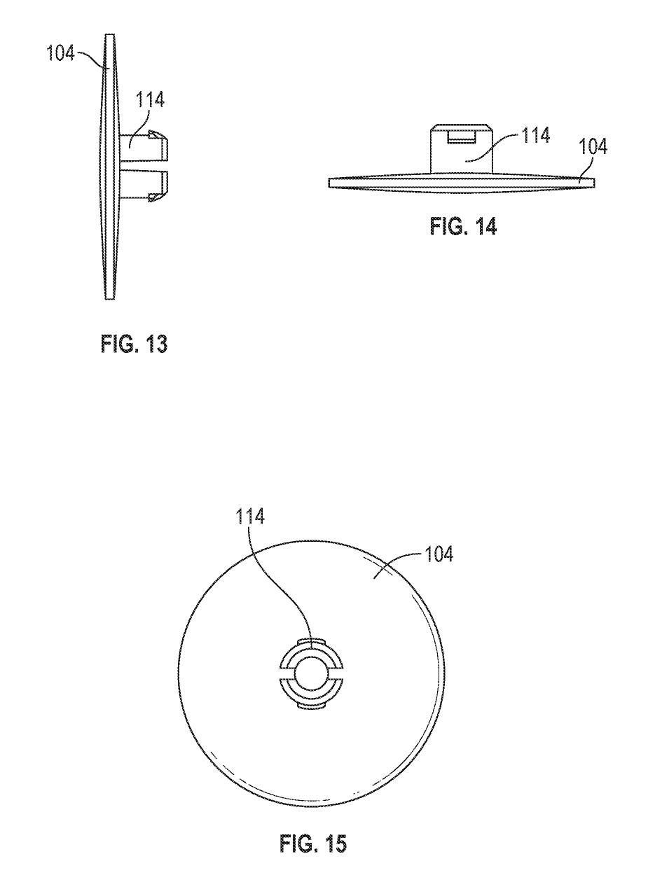

FIGS. 13-15 show side elevation and bottom plan views of the actuator 94, according to some embodiments of the present disclosure. The actuator 94 can be made of ABS plastic, optionally reinforced with fiberglass. The actuator 94 is removable and replaceable. The actuator 94 exemplified in FIGS. 13-15 integrates the platform 104 and the shaft 114 as a one-piece unit. The shaft 114 is split and tapered along a shaft axis, so that the shaft 114 is wider at its proximal end, where the shaft 114 meets the platform 104. The platform 104 is enlarged with respect to the size of the shaft 114, and with respect to the size of the pendant 122. In some embodiments, a diameter of the platform 104 is at least three times larger than the widest diameter of the shaft 114. The tapered shaft 114 is held in place in the opening 130 by a friction fit that offers resistance to being depressed. However, when sufficient force is applied transverse to the surface of the platform 104, the platform 104 and the shaft 114 move together with respect to the opening 130 so as to transfer pressure to the pendant 122 which is positioned directly underneath the opening 130. In some embodiments, the shaft 114 has an outer portion that is inserted and rotated to lock in place, while an inner portion attached to the platform 104 slides with respect to the outer portion. In some embodiments, an outer portion of the shaft 114 can be depressed to lock in place, allowing an inner portion of the shaft 114, attached to the platform 104, to move with respect to the outer portion.

Any other method of retaining the shaft 114 in the opening 130 can be used as long as the platform 104 is maintained at a proper distance from the top surface of the cover 102, e.g., about 5 mm, so as to offer resistance to applied pressure, and to make contact with the pendant 122. The actuator 94 operates as described above when an amount of pressure that can be reasonably supplied by a service animal is applied directly to the platform 104. The actuator 94 returns to its initial position in response to spring tension of the pendant 122. The pendant 122 may be made of a resilient material, or the pendant 122 may include one or more internal elements that provide spring tension. Existing alert system pendants 122 typically contain springs or similar devices that respond to pressure. In the embodiment shown, it is assumed that the pendant 122 is pressure-sensitive; however, the adaptive alert device 90 is not limited thereto. In some embodiments, the sensing aspect of the adaptive alert device 90 may operate according to other principles. For example, motion of the actuator 94 may interrupt a beam of light that triggers a light sensor within the pendant. In some embodiments, applying pressure to the actuator may cause a sound that triggers an audio sensor within the pendant, and so on.

The foregoing description, for purpose of explanation, has been made with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. An article of manufacture, comprising:
a housing forming an enclosure for an alert device;
a sensor within the housing;
an actuator that extends outside the housing, the actuator positioned to activate the sensor when the actuator is depressed; and
a wireless transmitter within the housing, the wireless transmitter configured to transmit a wireless signal from the alert device to a remote device in response to activation of the sensor.

2. The article of claim 1 wherein the actuator further includes
a platform outside the housing; and
a shaft having a proximal end coupled to the platform and a distal end in contact with the sensor.

3. The article of claim 2 wherein a surface of the platform has a surface area at least three times larger than a surface area of the sensor.

4. The article of claim 1 wherein the housing is made of an electrically non-conductive material.

5. The article of claim 1 wherein the wireless signal causes the remote device to dial a selected telephone number.

6. The article of claim 1 wherein the sensor is a pressure sensor.

7. The article of claim 6 wherein depression of the platform activates the alert device by exerting pressure on the pressure sensor.

8. The article of claim 2 wherein:
the sensor is an audio sensor; and
depression of the platform generates a sound that triggers the audio sensor.

9. The article of claim 1, further comprising:
a light emitter within the housing, the light emitter emitting a light beam in a direction transverse to the motion of the actuator; and
a light sensor within the alert device, motion of the actuator triggering the light sensor by interrupting the light beam.

10. The article of claim 1 wherein the wireless transmitter is inside a conventional alert pendant.

11. A communication system, comprising:
an adaptive alert device, including:
a housing;
a pendant inside the housing;
a wireless transmitter inside the pendant, the wireless transmitter configured to transmit a wireless signal from the adaptive alert device in response to activation of the sensor; and
an actuator that extends from outside the housing to inside the housing, the actuator positioned to activate the pendant in response to motion of the actuator; and
a remote device, communicatively coupled to the adaptive alert device, the remote device including:
a wireless receiver configured to receive the wireless signal;
a programmable memory; and
an auto-dialer configured to dial one or more selected telephone numbers stored in the programmable memory, in response to receiving the wireless signal.

12. The communication system of claim 11 wherein the remote device is further programmed to deliver a pre-recorded telephone message stored in the programmable memory.

13. The communication system of claim 12 wherein the pre-recorded telephone message includes location information associated with the pendant.

14. The communication system of claim 11 wherein the selected telephone number is stored in a memory of the auto-dialer.

15. The communication system of claim 11 wherein the pendant is secured in a fixed position within the housing.

16. An activation button for activation by a non-human entity, the activation button comprising:
a tapered shaft having a shaft axis; and
a platform coupled to the tapered shaft, the platform having a non-convex surface that extends in a direction transverse to the shaft axis, a diameter of the non-convex surface being at least three times larger than a diameter of the tapered shaft.

17. The activation button of claim 16 wherein the non-convex surface is substantially flat.

18. The activation button of claim 16 wherein the non-convex surface is concave.

19. The activation button of claim 16 wherein the platform has a color that reflects light of a wavelength that is visible by dogs.

20. The activation button of claim 16 wherein the platform and the tapered shaft are integrated as a one-piece unit.
